(19) United States
(12) Patent Application Publication
(10) Pub. No.: US 2022/0048579 A1
(43) Pub. Date: Feb. 17, 2022

(54) FRAME CONNECTION STRUCTURE

(71) Applicants: Hyundai Motor Company, Seoul (KR); Kai Motors Corporation, Seoul (KR)

(72) Inventor: Seongwook SEO, Hwaseon-si (KR)

(73) Assignees: Hyundai Motor Company, Seoul (KR); Kia Motors Corporation, Seoul (KR)

(21) Appl. No.: 17/165,696

(22) Filed: Feb. 2, 2021

(30) Foreign Application Priority Data
Aug. 12, 2020 (KR) 10-2020-0101287

(51) Int. Cl. B62D 27/06; F16B 7/18

(52) U.S. Cl. CPC B62D 27/06; F16B 7/18

(57) ABSTRACT

A frame connection structure may include a first frame including a frame hole, a joint mounted inside the first frame, a member inserted into the frame hole, and a connecting bracket connecting the member to the joint.

### CROSS-REFERENCE TO RELATED APPLICATION

The present application claims priority to Korean Patent Application No. 10-2020-0101287 filed on Aug. 12, 2020, the entire contents of which is incorporated herein for all purposes by this reference.

### BACKGROUND OF THE INVENTION

### Field of the Invention

The present invention relates to a frame connection structure. More particularly, the present invention relates to a frame connection structure for a vehicle.

### Description of Related Art

The frame is a part that installs various devices or vehicle bodies forming the chassis, and is a structure corresponding to the skeleton of the vehicle that supports the load transmitted from the vehicle body and the reaction force of the front and rear axles.

The space frame is a type of frame that forms a skeleton by welding steel plates or pipes, and has a merit which is light and high in strength.

As a method for improving working efficiency in a space frame, a method of applying a coupling structure to the external surface of a member is being studied.

However, if welding, adapter welding, bolting, etc. are applied to the outside of the member, fatigue and impact load may cause fracture due to the separation of the joint between the main member and the connecting member.

Furthermore, the welding joint is supported by only one side of the main member, and thus strength may be insufficient.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a frame connection structure configured for enhancing durability against fatigue and increasing torsional strength.

A frame connection structure according to various exemplary embodiments of the present invention may include a first frame including a frame hole, a joint mounted inside the first frame, a member inserted into the frame hole, and a connecting bracket connecting the member to the joint.

A joint stopper may be formed at the joint, and a bracket stopper corresponding to the joint stopper may be formed at the connecting bracket.

The frame connection structure according to various exemplary embodiments of the present invention may further include a cover having a cover hole into which the member is inserted and a first support portion supporting the first frame.

A first reinforce portion may be formed at the first support portion, and a cover hole reinforce portion may be formed around the cover hole.

The frame connection structure according to various exemplary embodiments of the present invention may further include a second frame connected to the first frame.

The frame connection structure according to various exemplary embodiments of the present invention may further include a cover of which a cover hole into which the member is inserted, a first support portion supporting the first frame and a second support portion supporting the second frame are formed thereto.

The cover may include a first reinforce portion formed on the first support portion, a second reinforce portion formed on the second support portion, and a cover hole reinforce portion formed around the cover hole.

The cover may further include a connection reinforce portion connecting the first reinforce portion and the second reinforce portion.

The cover may further include a reinforce plate connecting the first support portion and the second support portion.

The cover may further include an edge reinforce portion formed along an edge portion of the cover connecting the first support portion and the second support portion.

A frame connection structure according to various exemplary embodiments of the present invention may include a first frame including a frame hole, a joint mounted inside the first frame and of which a joint stopper is formed thereto, and a member inserted into the frame hole, of which a bracket stopper corresponding to the joint stopper is formed thereto, and the member connected to the joint.

The frame connection structure may further include a cover having a cover hole into which the member is inserted and a first support portion supporting the first frame.

A first reinforce portion may be formed at the first support portion, and a cover hole reinforce portion is formed around the cover hole.

The frame connection structure may further include a second frame connected to the first frame.

The frame connection structure may further include a cover of which a cover hole into which the member is inserted, a first support portion supporting the first frame and a second support portion supporting the second frame are formed thereto.

The cover may include a first reinforce portion formed on the first support portion, a second reinforce portion formed on the second support portion, and a cover hole reinforce portion formed around the cover hole.

The cover may further include a connection reinforce portion connecting the first reinforce portion and the second reinforce portion.

The cover may further include a reinforce plate connecting the first support portion and the second support portion.

The cover may further include an edge reinforce portion formed along an edge portion of the cover connecting the first support portion and the second support portion.

According to the frame connection structure, it is possible to strengthen durability against fatigue and increase torsional strength.

Furthermore, the effect obtained or predicted by various exemplary embodiments of the present invention will be included directly or implicitly in the detailed description of various exemplary embodiments of the present invention. That is, various effects predicted according to various exemplary embodiments of the present invention will be included within a detailed description to be described later.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

Since these drawings are for reference only to describe various exemplary embodiments of the present invention, the technical idea of the present invention may not be interpreted as being limited to the accompanying drawing.

FIG. 1 is a perspective view of a vehicle body to which a frame connection structure according to various exemplary embodiments of the present invention may be applied.

FIG. 2 is a projection perspective view of the frame connection structure according to various exemplary embodiments of the present invention.

FIG. 3, FIG. 4 and to FIG. 5 are drawings showing assemble processes of the frame connection structure according to various exemplary embodiments of the present invention.

FIG. 6A, FIG. 6B and FIG. 6C are drawings showing examples of joints which may be applied to the frame connection structure according to various exemplary embodiments of the present invention.

FIG. 7A, FIG. 7B, FIG. 7C and FIG. 7D are drawing showing examples of connection brackets which may be applied to the frame connection structure according to various exemplary embodiments of the present invention.

FIG. 8A and FIG. 8B are drawings showing examples of covers which may be applied to the frame connection structure according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

In the following detailed description, only certain exemplary embodiments of the present invention have been shown and described, simply by way of illustration.

As those skilled in the art would realize, the described embodiments may be modified in various different ways, all without departing from the spirit or scope of the present invention

Parts marked with the same reference number throughout the specification mean the same constituent elements.

In the drawings, the thickness of layers, films, panels, regions, etc., are exaggerated for clarity.

When a part such as a layer, film, region, or plate is said to be “on” another part, this includes not only the case directly above the other part, but also the case where there is another part in the middle.

In contrast, when an element is referred to as being “directly on” another element, there are no intervening elements present.

Throughout the specification, when a part “includes” a certain component, it means that other components may be further included rather than excluding other components unless otherwise stated.

Various exemplary embodiments of the present invention will hereinafter be described in detail with reference to the accompanying drawings.

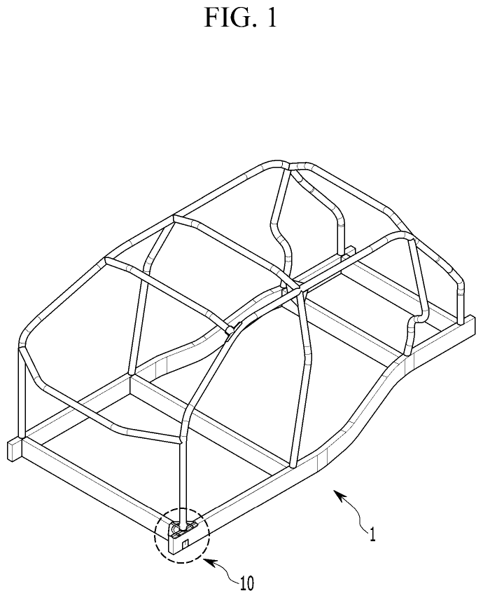

FIG. 1 is a perspective view of a vehicle body to which a frame connection structure according to various exemplary embodiments of the present invention may be applied.

As shown in FIG. 1, a vehicle body 1 to which the frame connection structure according to various exemplary embodiments of the present invention may be applied may be a space frame including a skeleton by welding steel plates or pipes, but is not limited thereto, and may be applied to various configurations connecting the frame and components.

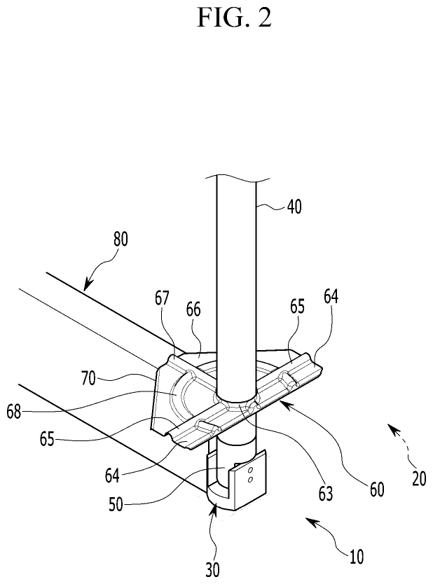

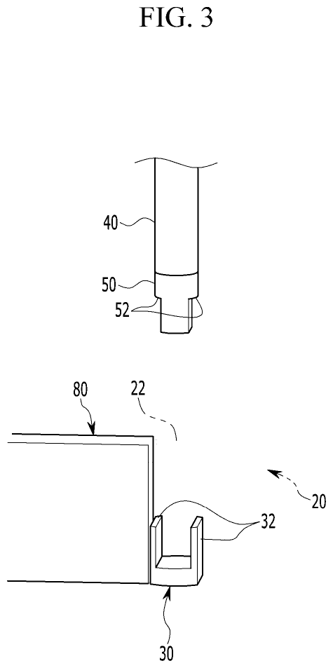

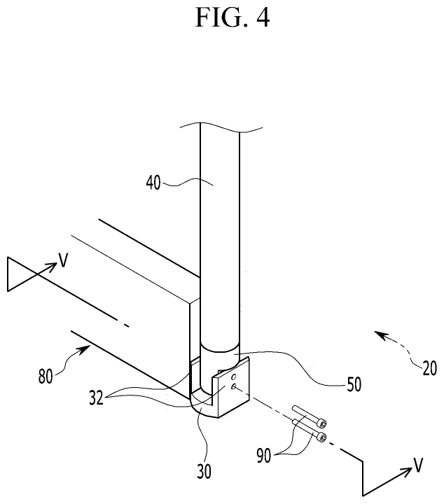

FIG. 2 is a projection perspective view of the frame connection structure according to various exemplary embodiments of the present invention, and FIG. 3, FIG. 4 and to FIG. 5 are drawings showing assemble processes of the frame connection structure according to various exemplary embodiments of the present invention.

Referring to FIG. 2 to FIG. 5, a frame connection structure 10 according to various exemplary embodiments of the present invention includes a first frame 20 in which a frame hole 22 is formed, a joint 30 mounted inside the first frame 20, a member 40 inserted into the frame hole 22 and a connecting bracket 50 connecting the member 40 to the joint 30.

Here, the first frame 20 and the member 40 are parts that form the skeleton of the vehicle body 1, and as shown in the drawing, the first frame 20 may be in a form of a hollow rail or a beam, and the member 40 may be a pipe, but is not limited thereto.

A joint stopper 32 may be formed at the joint 30, and a bracket stopper 52 corresponding to the joint stopper 32 may be formed at the connecting bracket 50.

The frame connection structure 10 according to various exemplary embodiments of the present invention may further include a cover 60 in which a cover hole 62 into which the member 40 is inserted and a first support portion 64 supporting the first frame 20 are formed.

The cover 60 is connected to the first frame 20, and the member 40 may be firmly fixed to the first frame 20 through the cover hole 62.

The first reinforce portion 65 may be formed at the first support portion 64, and the first reinforce portion 65 has a shape protruded to the outside thereof, and the strength may be increased.

Around the cover hole 62, a cover hole reinforce portion 63 may be formed, and the cover hole reinforce portion 63 has a shape protruded to the outside, and the strength may be increased.

The frame connection structure 10 according to various exemplary embodiments of the present invention may further include a second frame 80 connected to the first frame 20.

That is, the frame connection structure 10 according to various exemplary embodiments of the present invention may be used to fix the member 40 inside one frame 20, as shown in FIG. 2, it can also be used to fix the member 40 in the area where the first frame 20 and the second frame 80 are connected to.

The frame connection structure 10 according to various exemplary embodiments of the present invention may further include a cover 60 on which a second support portion 66 supporting the second frame 80 is formed.

The cover 60 may further include a second reinforce portion 67 formed on the second support portion 66, and the second reinforce portion 67 has a shape protruded to the outside thereof, increasing strength.

The cover 60 may further include a connection reinforce portion 68 that connects the first reinforce portion 65 and the second reinforce portion 67, and the connection reinforce portion 68 has a shape protruded outwardly, and strength may be increased.

Hereinafter, referring to FIG. 3 to FIG. 5, assembly of the frame connection structure 10 according to various exemplary embodiments of the present invention will be described.

The joint 30 is combined to inside the first frame 20 or inside the first frame 20 connected to the second frame 80. The first frame 20 and the joint 30 may be welded or glued together.

The connecting bracket 50 connected to the member 40 is inserted through the frame hole 22 and is connect with the joint 30. The member 40 and the connecting bracket 50 may be welded or bonded, and the connecting bracket 50 and the joint 30 may be bonded or connected through a bolt 90.

After the member 40 is inserted into the cover hole 62 of the cover 60, it may be combined with the joint 30, or the cover 60 may be combined by inserting the member 40 into the cover hole 62 after the connecting bracket 50 and the joint 30 are connected.

The cover 60 may be welded, bolted, or glued to the first frame 20 or the first frame 20 and the second frame 80.

In the drawings, the cover hole reinforce portion 63, the first reinforce portion 65, the second reinforce portion 67 and the connection reinforce portion 68 are each shown in a semicircular protrude shape, but are not limited thereto. The cover hole reinforce portion 63, the first reinforce portion 65, the second reinforce portion 67 and the connection reinforce portion 68 are available in various shapes that increase the torsional strength for the first frame 20, the member 40 and the second frame 80.

The first reinforce portion 65 and the second reinforce portion 67 are formed in the longitudinal direction of the first frame 20 or the second frame 80, respectively, to increase the torsional strength.

The connection reinforce portion 68 is formed in the circumferential direction around the cover hole reinforce portion 63 to further increase the strength of the first reinforce portion 65 and the second reinforce portion 67.

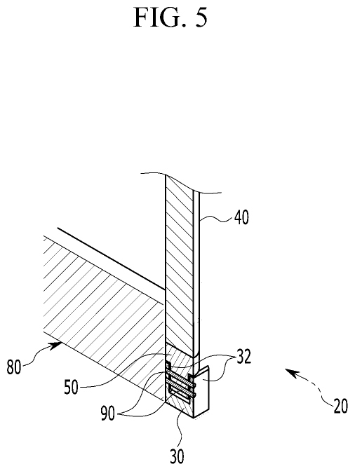

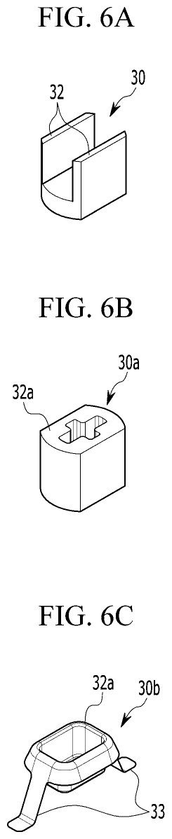

FIG. 6A, FIG. 6B and FIG. 6C are drawings showing examples of joints which may be applied to the frame connection structure according to various exemplary embodiments of the present invention.

As shown in FIG. 6A, the joint 30, which may be applied to the frame connection structure according to various exemplary embodiments of the present invention, has two joint stoppers 32 and may be assembled with the connecting bracket 50.

As shown in FIG. 6B, a joint 30a may be assembled with the connecting bracket 50 through a polygonal joint stopper 32a. The cross shape shown in the drawing corresponds to an example, and the shape of the polygon is not limited thereto.

As shown in FIG. 6C, a joint 30b may be formed with a joint stopper 32b of a square shape, and may be assembled with the connecting bracket 50, and may be supported by the support portion 33.

The joint which may be applied to the frame connection structure according to various exemplary embodiments of the present invention is not limited to the shape shown in FIG. 6, but may be manufactured in various shapes.

The joints 30, 30, and 30b are inserted into the first frame 20 and may be welded, bolted or bonded to the side and bottom surfaces of the first frame 20, respectively. That is, it may be combined on three sides, so that the joint 30, 30, 30b and the first frame 20 may be securely combined.

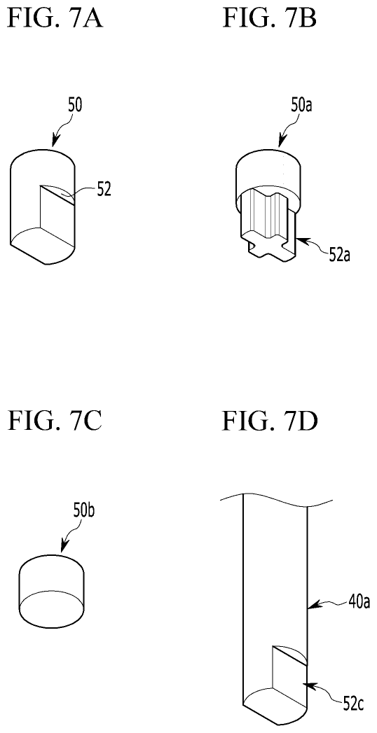

FIG. 7A, FIG. 7B, FIG. 7C and FIG. 7D are drawing showing examples of connection brackets which may be applied to the frame connection structure according to various exemplary embodiments of the present invention.

As shown in FIG. 7A, the connecting bracket 50 applicable to the frame connection structure according to various exemplary embodiments of the present invention may include the bracket stopper 52 formed on both sides contacting to the joint stopper 32 to fix and support the connecting bracket 50.

As shown in FIG. 7B, the connecting bracket 50a which may be applied to the frame connection structure according to various exemplary embodiments of the present invention may include a bracket stopper 52a corresponding to the polygonal joint stopper 32a, and the connecting bracket 50a may be fixed and supported by assembling the joint stopper 32a and the bracket stopper 52a.

As shown in FIG. 7C, the connecting bracket 50b, which may be applied to the frame connection structure according to various exemplary embodiments of the present invention, has a circular cylinder shape and may be bonded by bolting or bonding to a joint.

As shown in FIG. 7D, a member 40a formed with a joint stopper may be applied to the frame connection structure according to various exemplary embodiments of the present invention. For example a bracket stopper 52c corresponding to the joint stopper 32 shown in the FIG. 6A is formed at one end portion of member 40a, and which may be connected to the joint 30. In other words, the end portion of the member may be processed and connected to the joint without a separate connecting bracket.

Depending on the shapes of the joint stopper 32, 32a, and 32b and the bracket stopper 52, 52a, 52b, and 52c, the joint position and insert depth of the joint 30, 30, and 30b and the connecting bracket 50, 50a, 50b, and 50c may be determined.

The joints 30, 30, and 30b and the connecting brackets 50, 50a, 50b, and 50c may be connected by screwing, bolting, and adhesive bonding.

The joints 30, 30, and 30b is configured as guides in connection with the connecting brackets 50, 50a, 50b, and 50c.

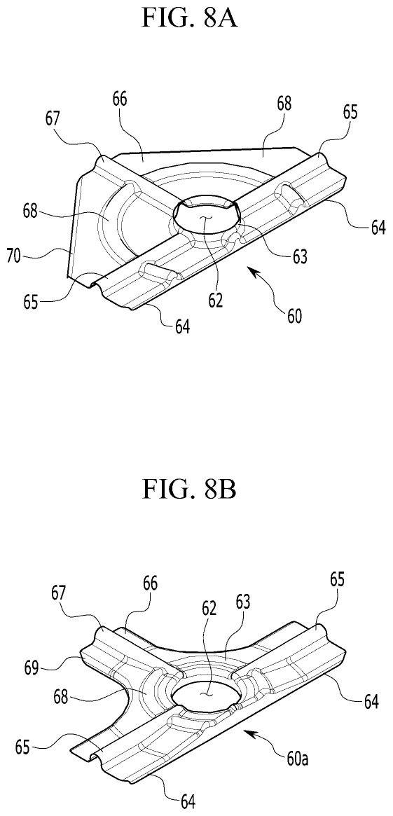

FIG. 8A and FIG. 8B are drawings showing examples of covers which may be applied to the frame connection structure according to various exemplary embodiments of the present invention.

As shown in FIG. 8A, the cover 60 may further include a reinforce plate 70 formed to connect the first support portion 64 and the second support portion 66.

Since the reinforce plate 70 is configured to connect the first support portion 64 and the second support portion 66, the strength against torsion may be increased.

Also, as shown in FIG. 8B, an edge reinforce portion 69 may be formed along an edge portion connecting the first support portion 64 and the second support portion 66. The edge reinforce portion 69 can increase the strength against torsion of the cover 60a by bending the edge portion connecting the first support portion 64 and the second support portion 66.

In the frame connection structure according to various exemplary embodiments of the present invention, a joint structure is added inside the frame, so that a structure design in consideration of a load path is possible.

Furthermore, the joint may be positioned within the frame to secure a welding surface, and a cover may be provided to secure strength against deformation.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A frame connection structure comprising:
a first frame including a frame hole;
a joint mounted inside the first frame;
a member inserted into the frame hole; and
a connecting bracket connecting the member to the joint.

2. The frame connection structure of claim 1,
wherein a joint stopper is formed at the joint; and
wherein a bracket stopper corresponding to the joint stopper is formed at the connecting bracket.

3. The frame connection structure of claim 1, further including a cover having:
a cover hole into which the member is inserted; and
a first support portion supporting the first frame.

4. The frame connection structure of claim 3,
wherein a first reinforce portion is formed at the first support portion; and
wherein a cover hole reinforce portion is formed around the cover hole.

5. The frame connection structure of claim 1, further including a second frame connected to the first frame.

6. The frame connection structure of claim 5, further including a cover having:
a cover hole into which the member is inserted;
a first support portion supporting the first frame; and
a second support portion supporting the second frame.

7. The frame connection structure of claim 6, wherein the cover further includes:
a first reinforce portion formed on the first support portion;
a second reinforce portion formed on the second support portion; and
a cover hole reinforce portion formed around the cover hole.

8. The frame connection structure of claim 7, wherein the cover further includes a connection reinforce portion connecting the first reinforce portion and the second reinforce portion.

9. The frame connection structure of claim 6, wherein the cover further includes a reinforce plate connecting the first support portion and the second support portion.

10. The frame connection structure of claim 6, wherein the cover further includes an edge reinforce portion formed along an edge portion of the cover connecting the first support portion and the second support portion.

11. A frame connection structure comprising:
a first frame including a frame hole;
a joint mounted inside the first frame, wherein the joint includes a joint stopper; and
a member inserted into the frame hole and connected to the joint, wherein a bracket stopper corresponding to the joint stopper is formed at the member.

12. The frame connection structure of claim 11, further including:
a cover having a cover hole into which the member is inserted; and
a first support portion supporting the first frame.

13. The frame connection structure of claim 12,
wherein a first reinforce portion is formed at the first support portion; and
wherein a cover hole reinforce portion is formed around the cover hole.

14. The frame connection structure of claim 11, further including a second frame connected to the first frame.

15. The frame connection structure of claim 14, further including a cover having:
a cover hole into which the member is inserted;
a first support portion supporting the first frame; and
a second support portion supporting the second frame.

16. The frame connection structure of claim 15, wherein the cover further includes:
a first reinforce portion formed on the first support portion;
a second reinforce portion formed on the second support portion; and
a cover hole reinforce portion formed around the cover hole.

17. The frame connection structure of claim 16, wherein the cover further includes a connection reinforce portion connecting the first reinforce portion and the second reinforce portion.

18. The frame connection structure of claim 15, wherein the cover further includes a reinforce plate connecting the first support portion and the second support portion.

19. The frame connection structure of claim 15, wherein the cover further includes an edge reinforce portion formed along an edge portion of the cover connecting the first support portion and the second support portion.

20. The frame connection structure of claim 16,
wherein the first reinforce portion is aligned along the first frame, and
wherein the second reinforce portion is aligned along the second frame.
